(19) United States
(12) Patent Application Publication
(10) Pub. No.: US 2004/0022591 A1
(43) Pub. Date: Feb. 5, 2004

(54) Spot eliminator

(76) Inventor: Glenroy P. Wright, Boston, MA (US)

Correspondence Address: GLENROY P. WRIGHT, 80 Wildwood St., Mattapan, MA, 02126, US

(21) Appl. No.: 10/174,192

(22) Filed: Jun. 10, 2002

(51) Int. Cl. B26D 1/00; B26D 3/00; B23P 15/28

(52) U.S. Cl. 407/77

(57) ABSTRACT

The spot eliminator is a secondary metal processing tool holder used in CNC and conventional turning applications, this tool holder accommodates metal cutting inserts and various other cutting tools, all shapes and type enabling the mechanic to find the center of the part been machine regardless of machine working conditions, especially where automated machinery is the primary tool. The spot eliminator eliminates obstacle in these machinery by providing adjustability where these machine have none with conventional or unconventional tools. Unconventional meaning: unusual, homemade. The tool body consists of a guiding wedge that locates the tool holder head and aligns it for clamping, and adjusting. The tool heads are interchangeable with its body type making them unique in this regard, the tool head provides for clamping of tools and inserts. Both parts are uniquely designed to ensure smooth action and maximum strength under any working condition.

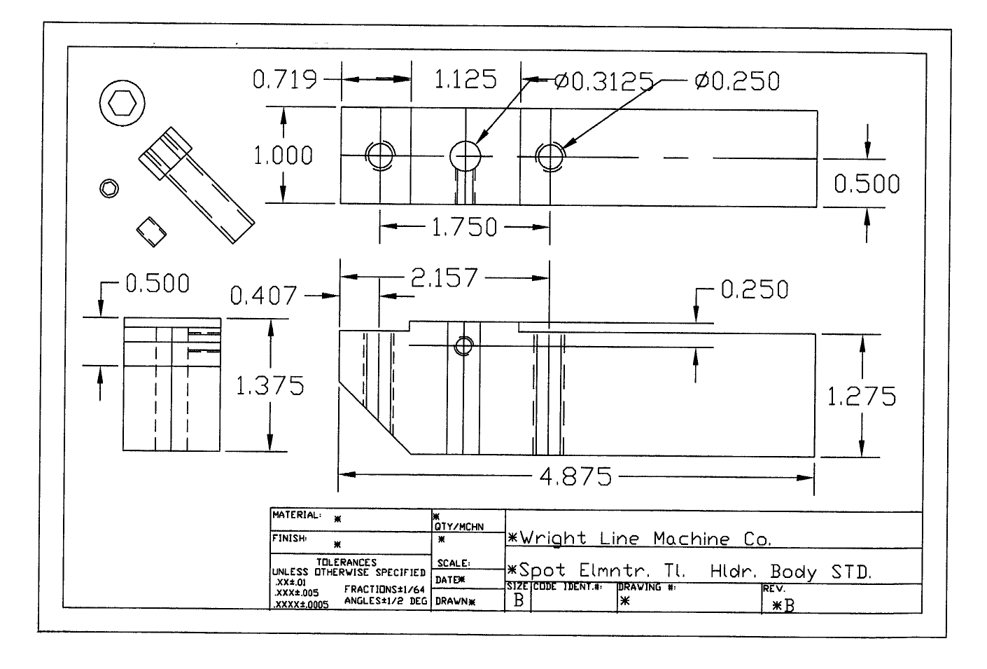

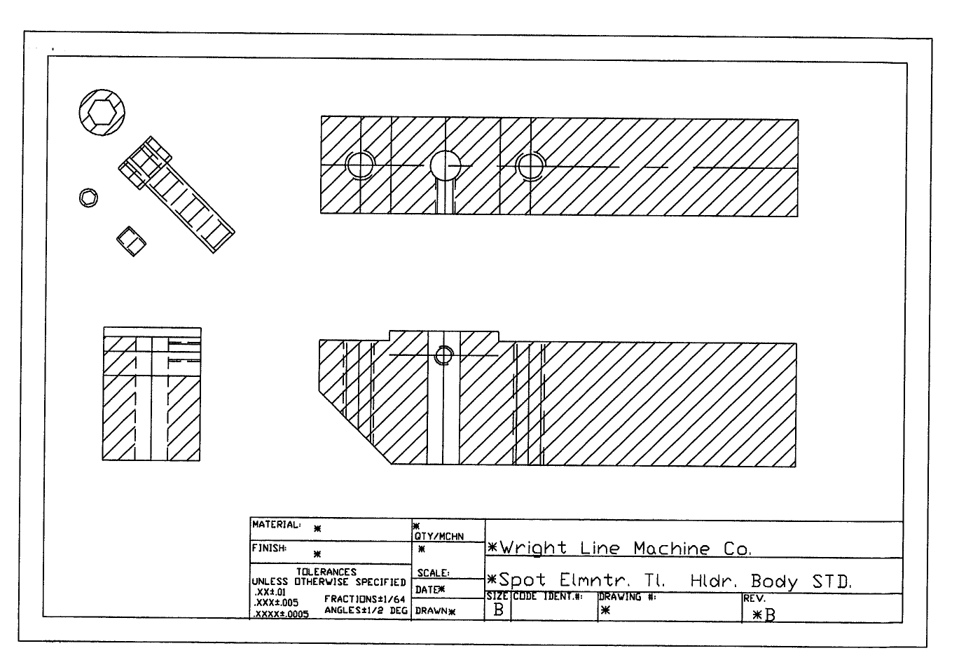

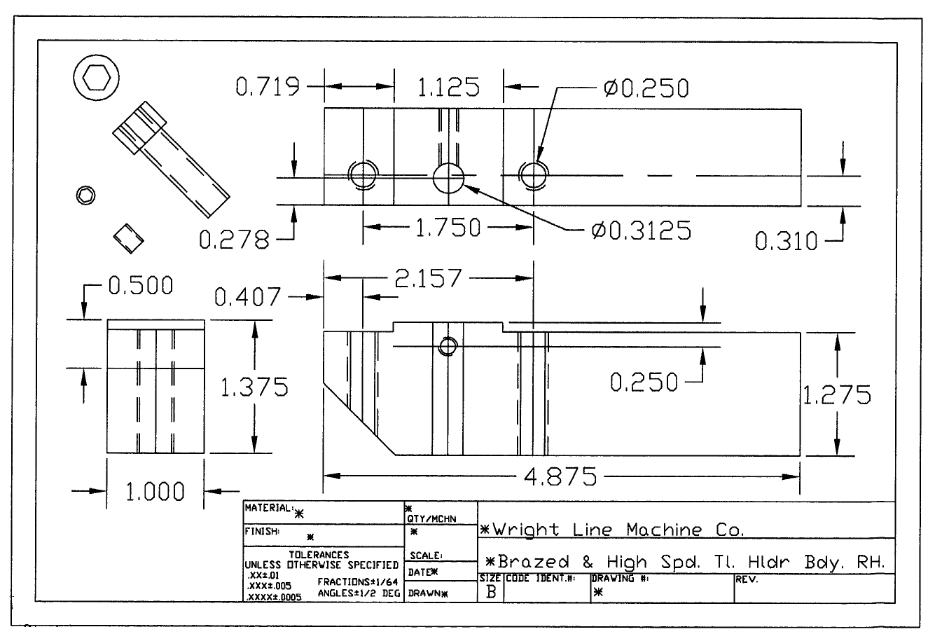

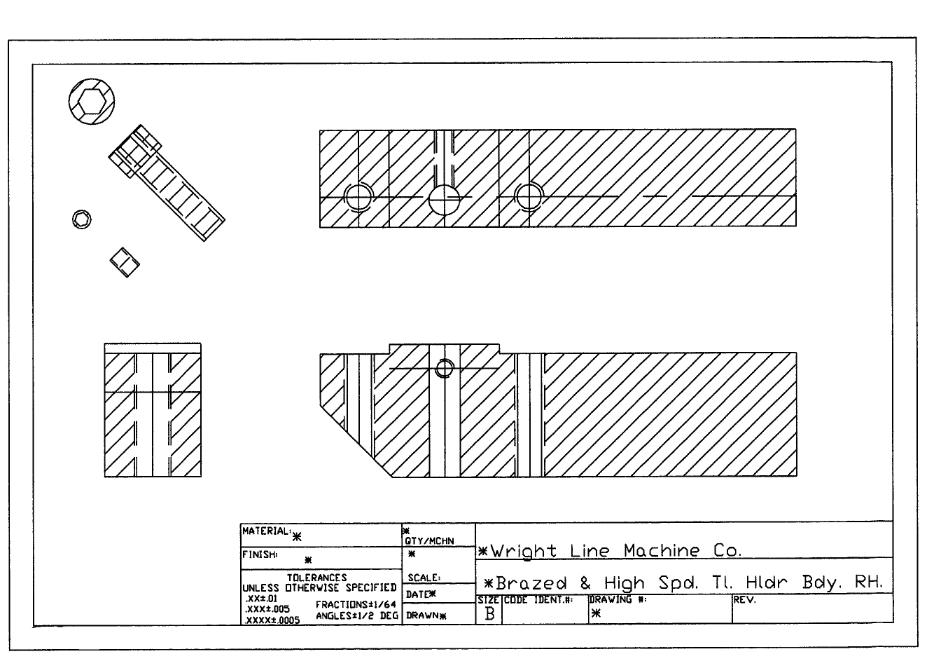

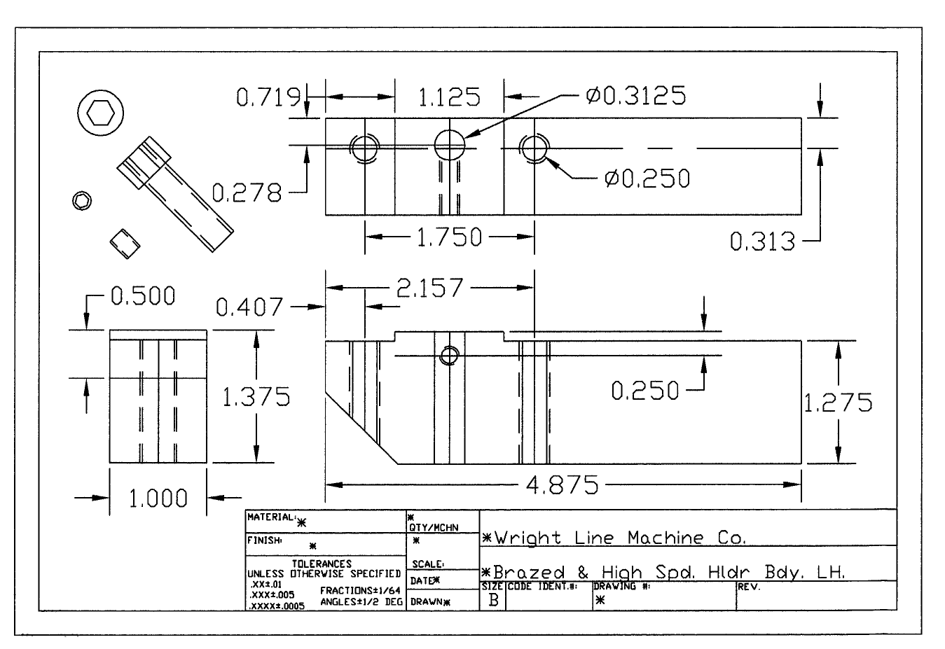

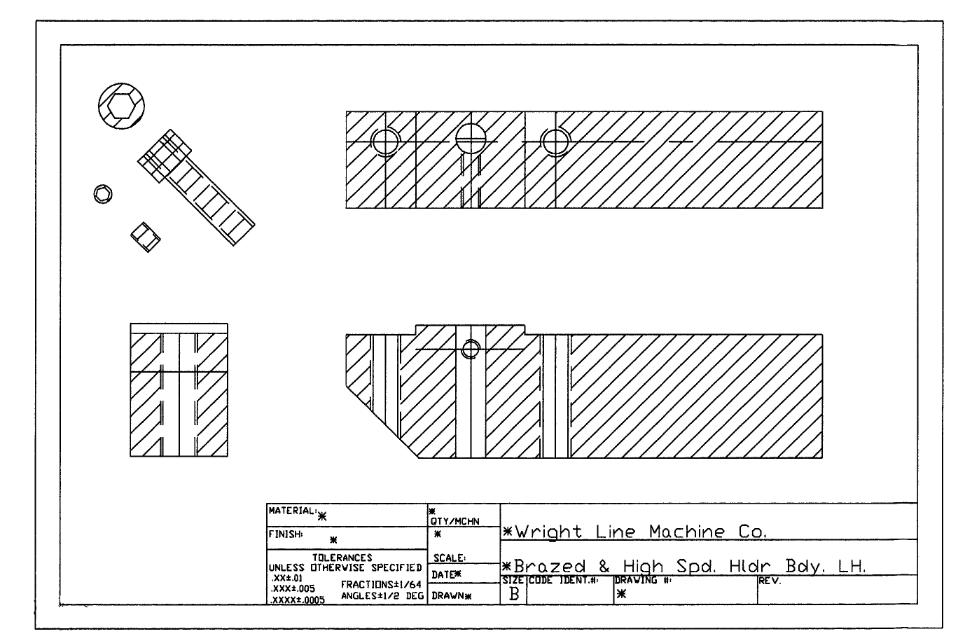

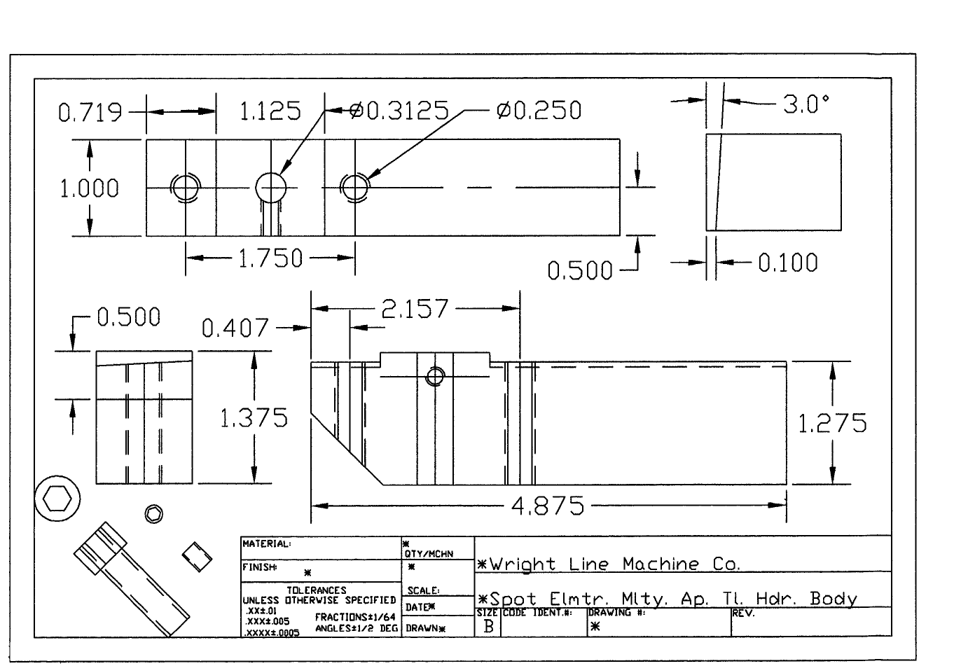

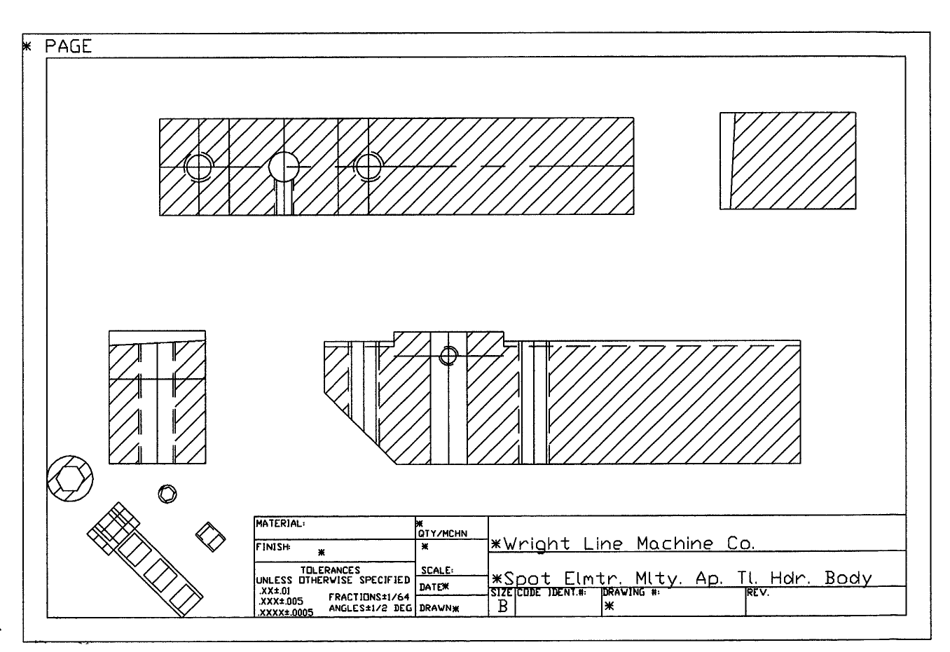

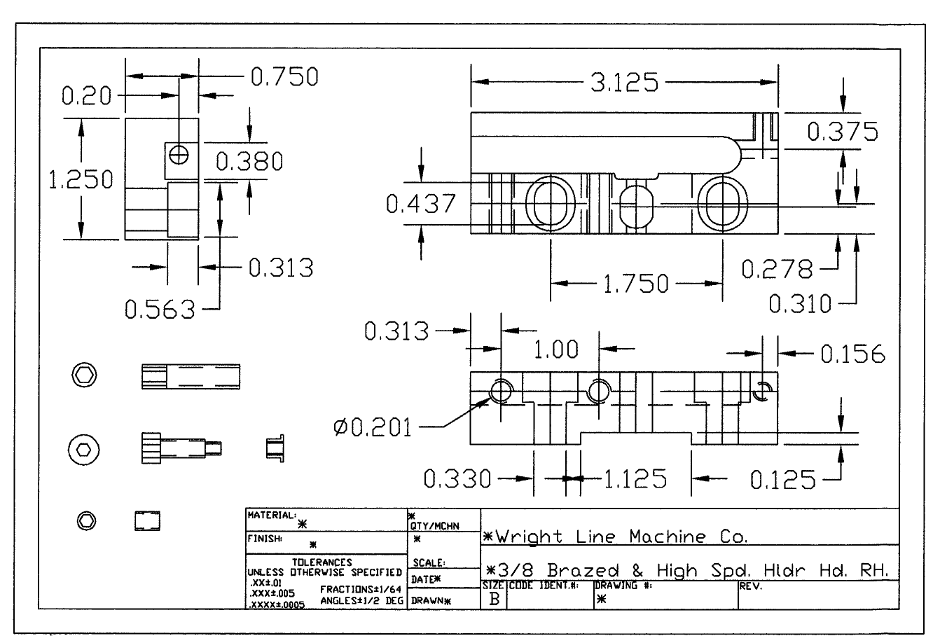

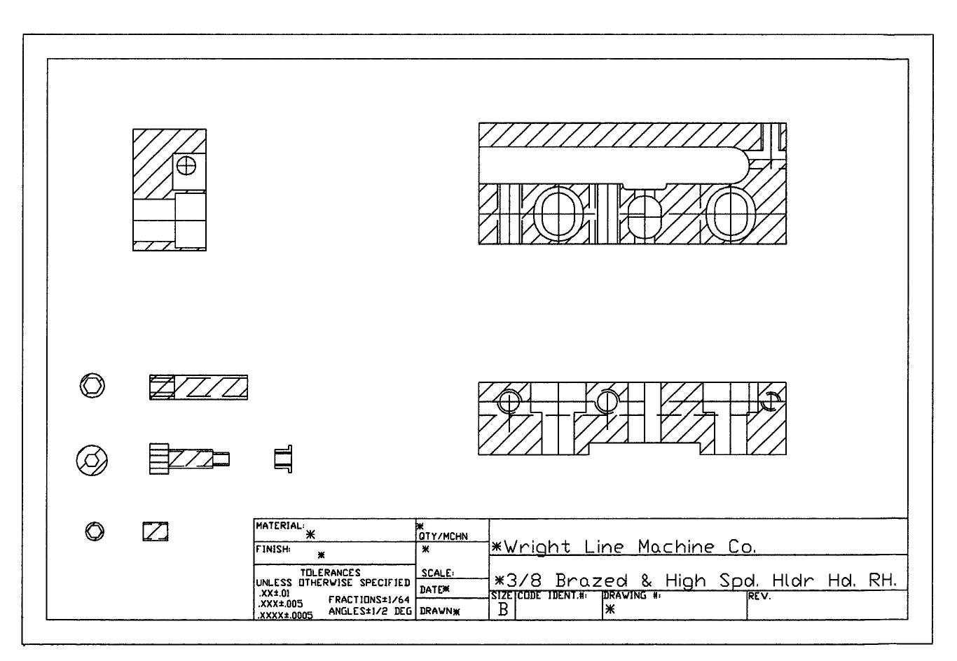

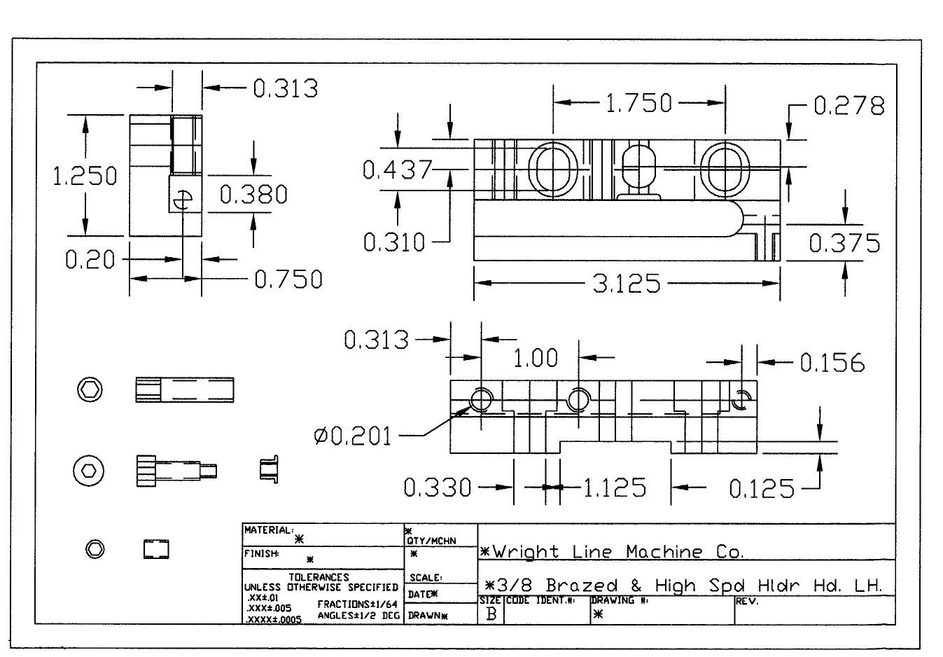

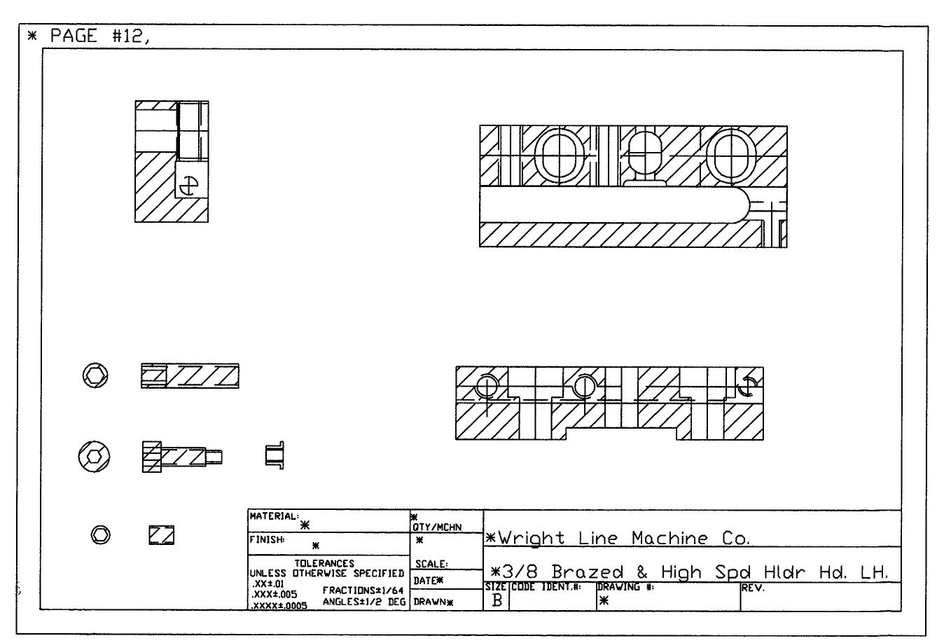

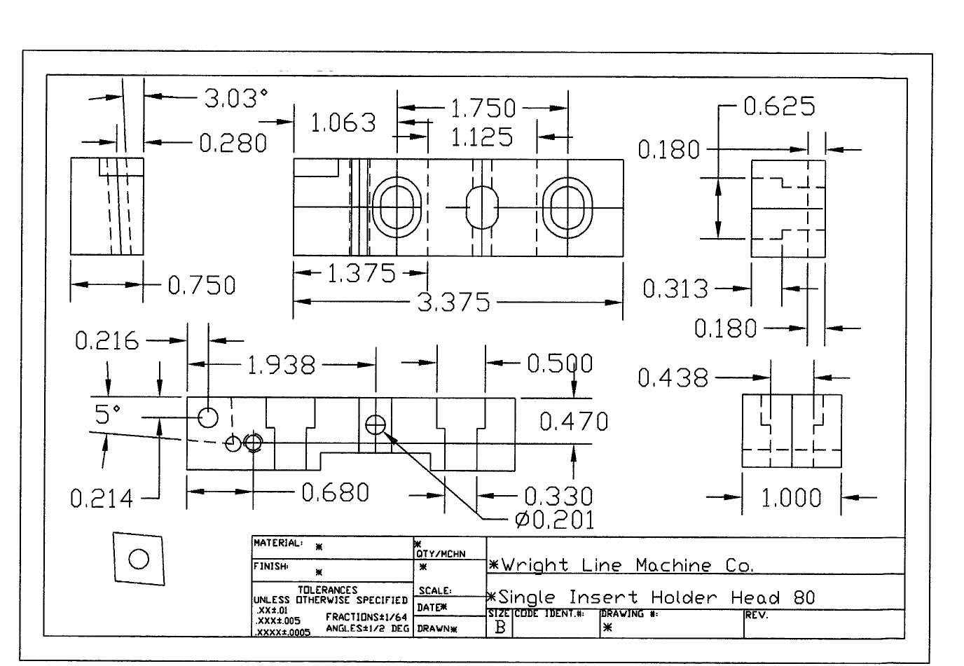

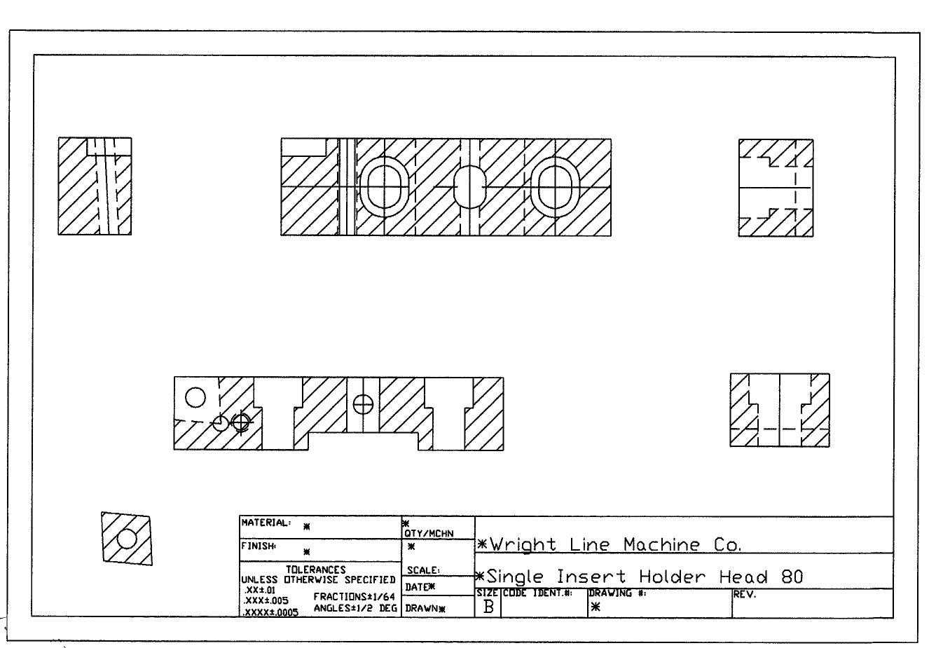

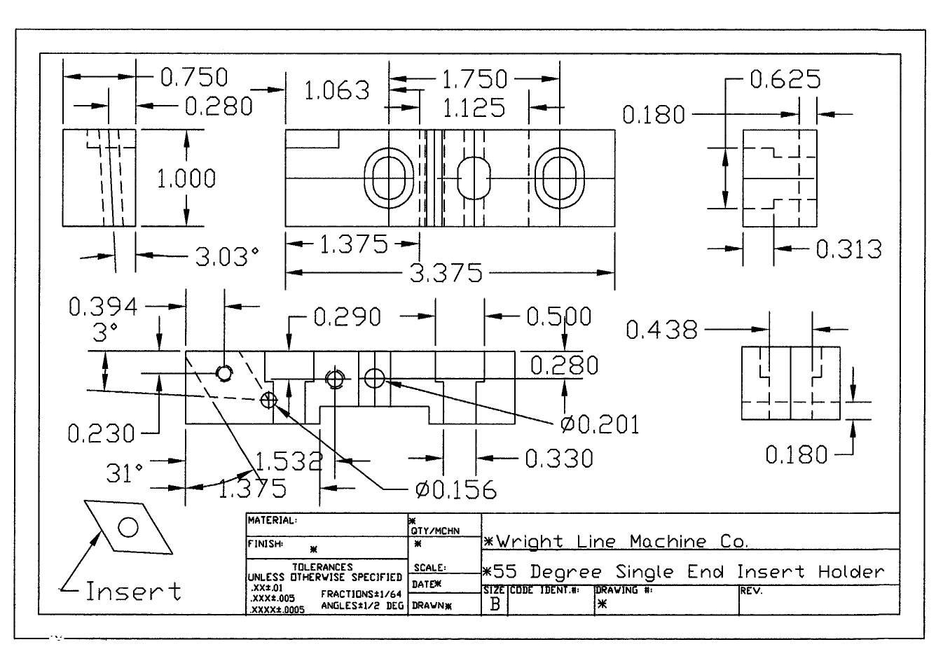

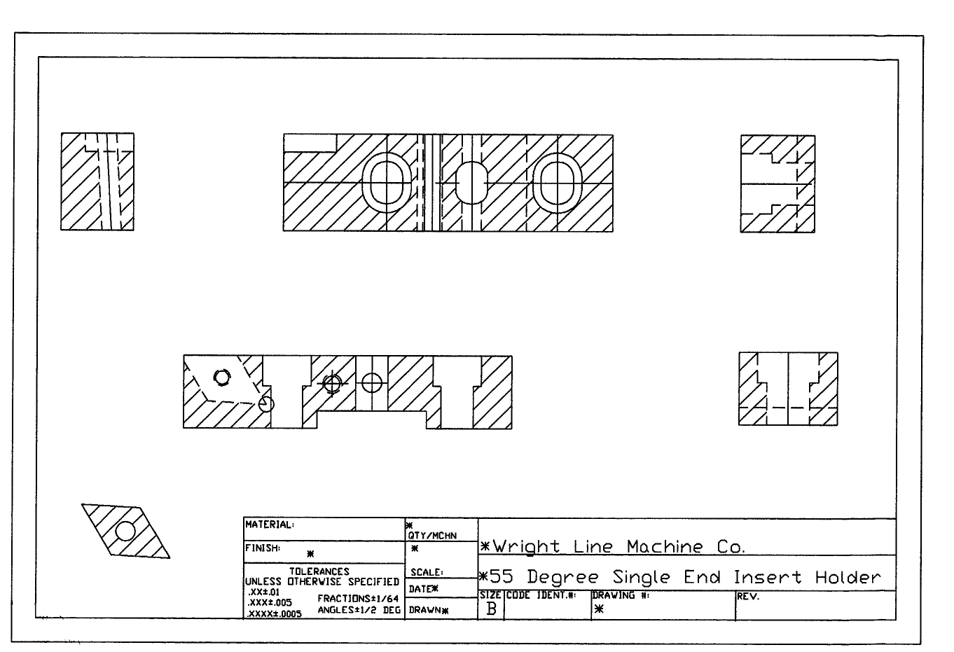

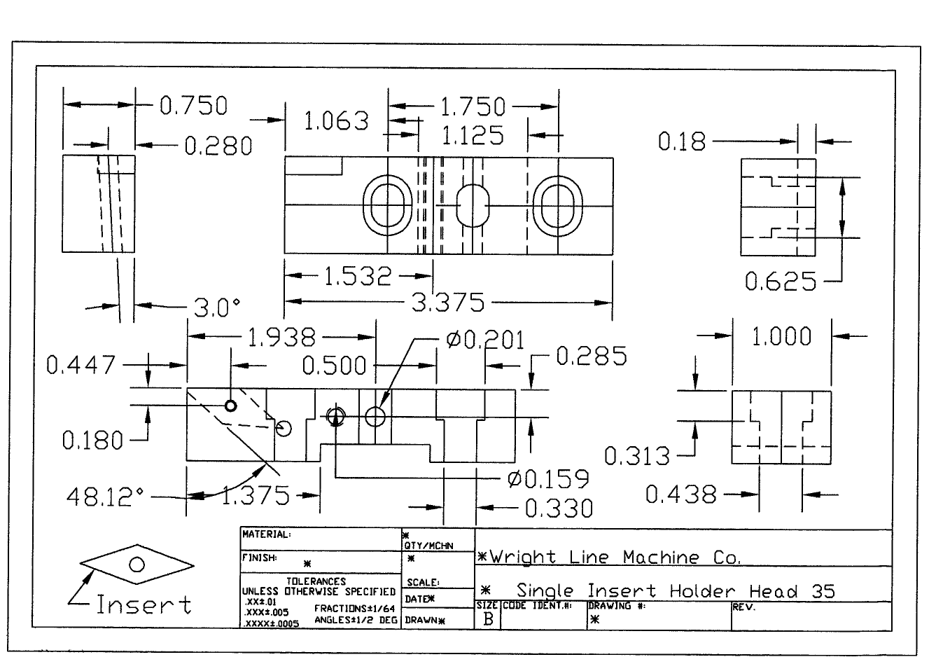

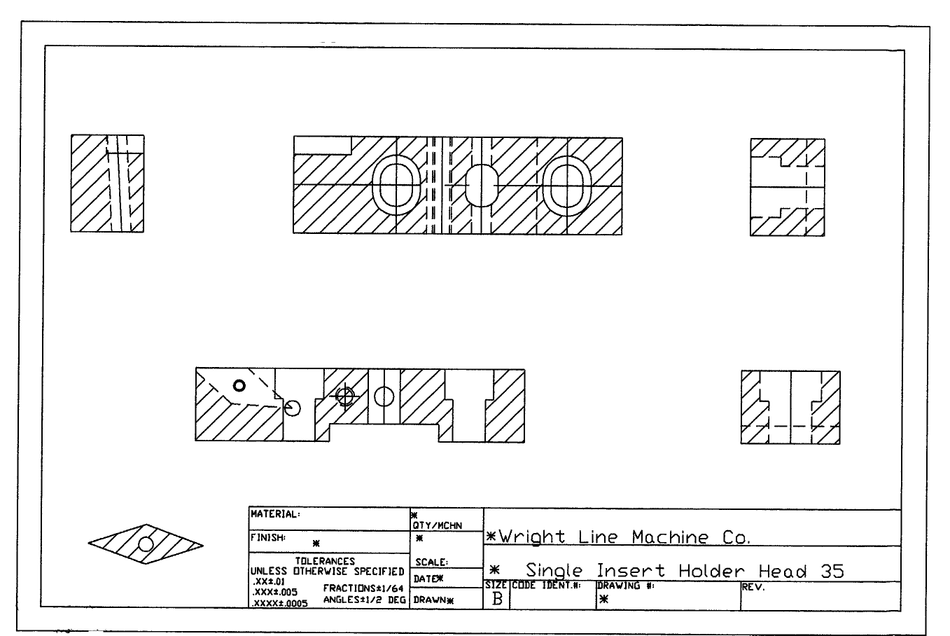

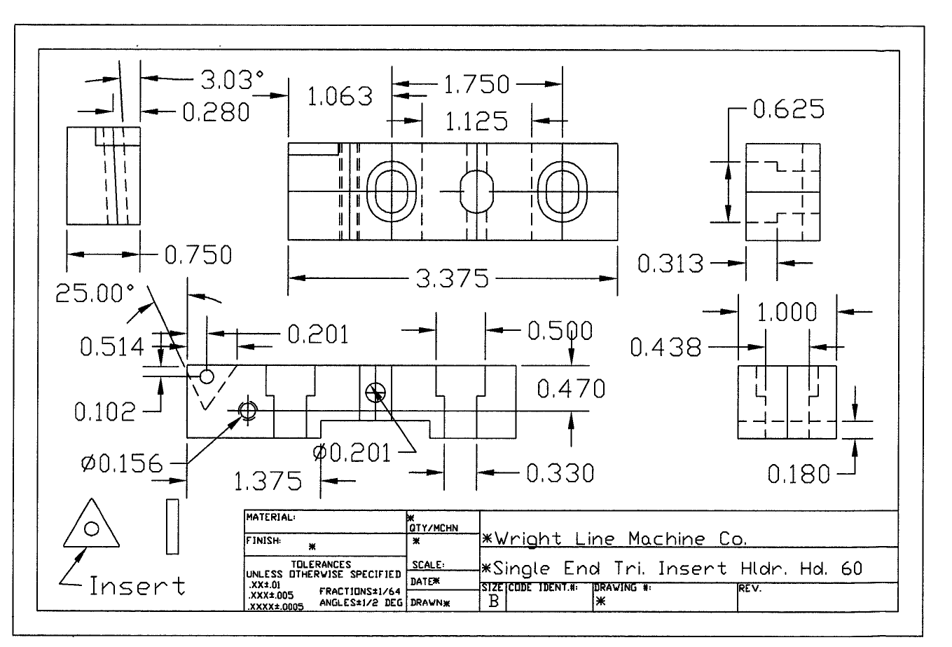

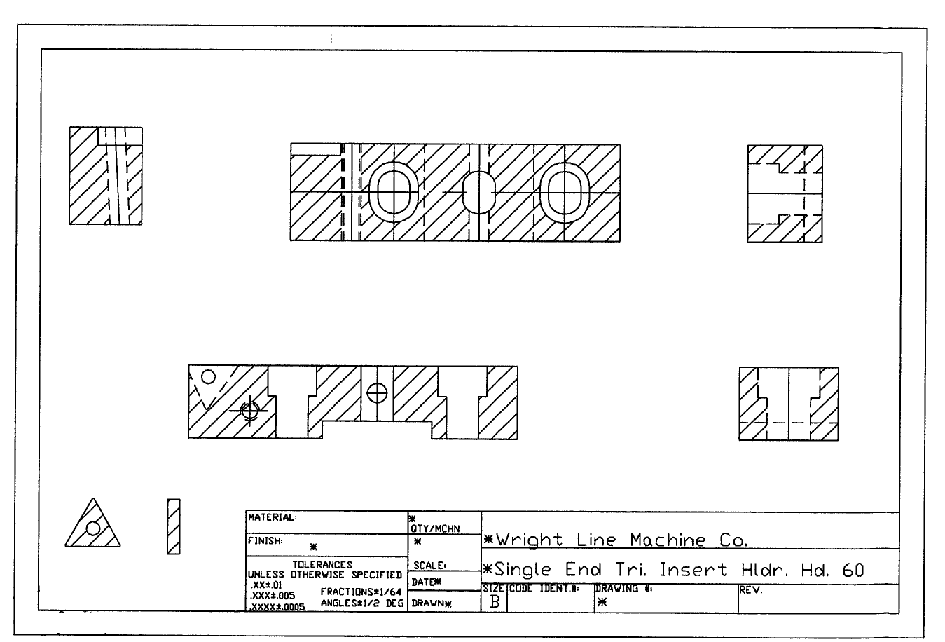

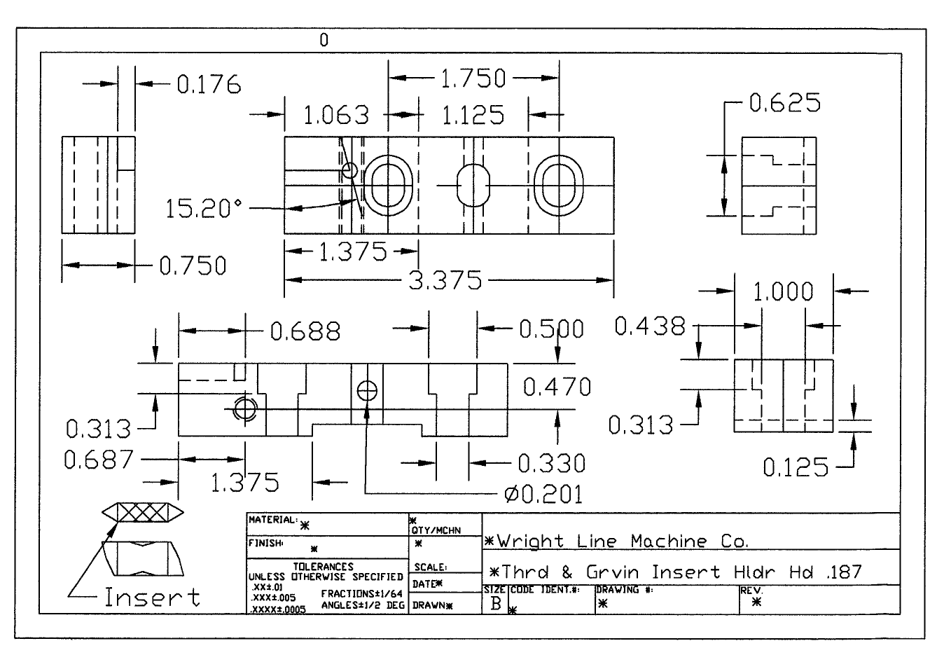

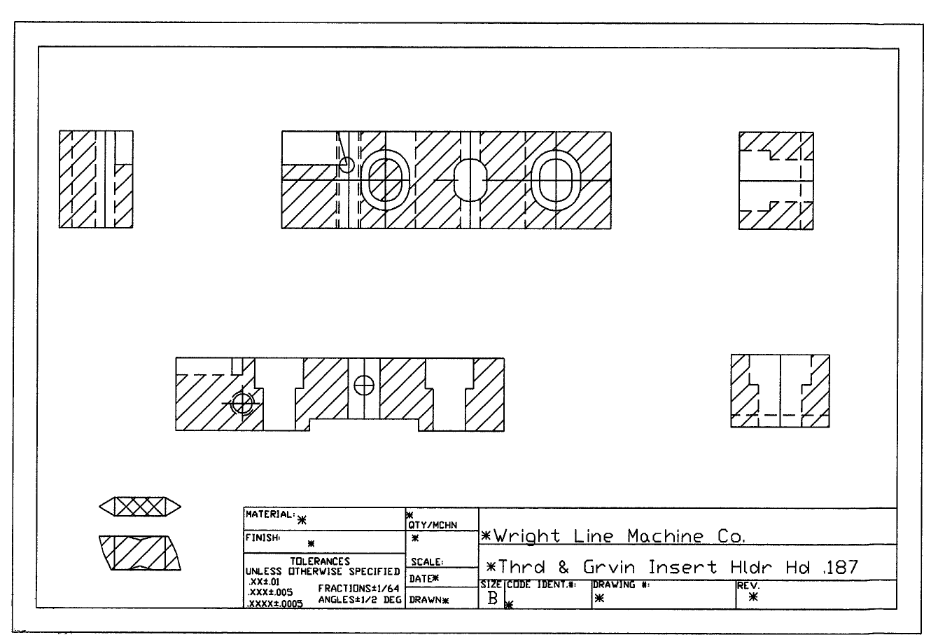

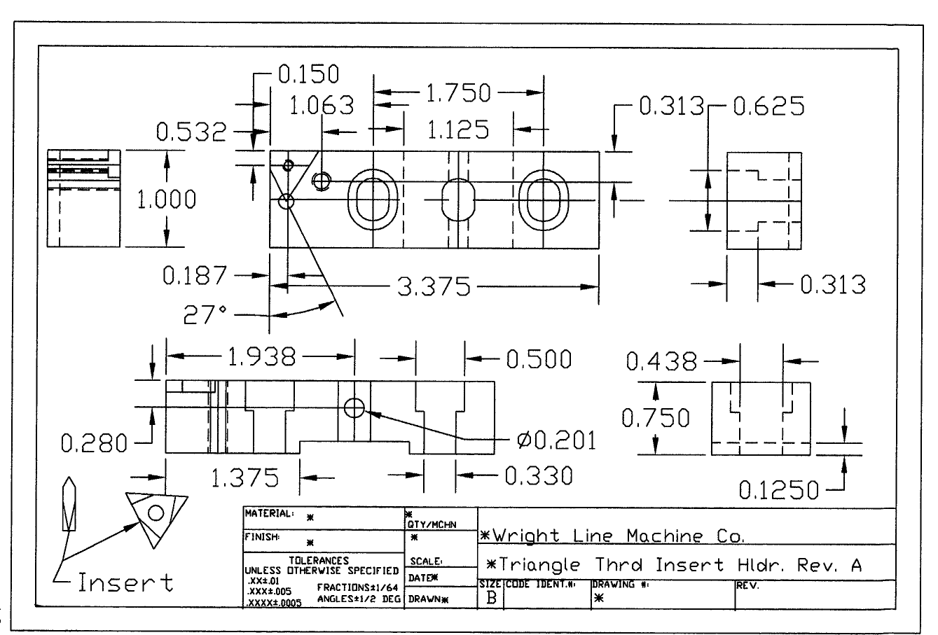

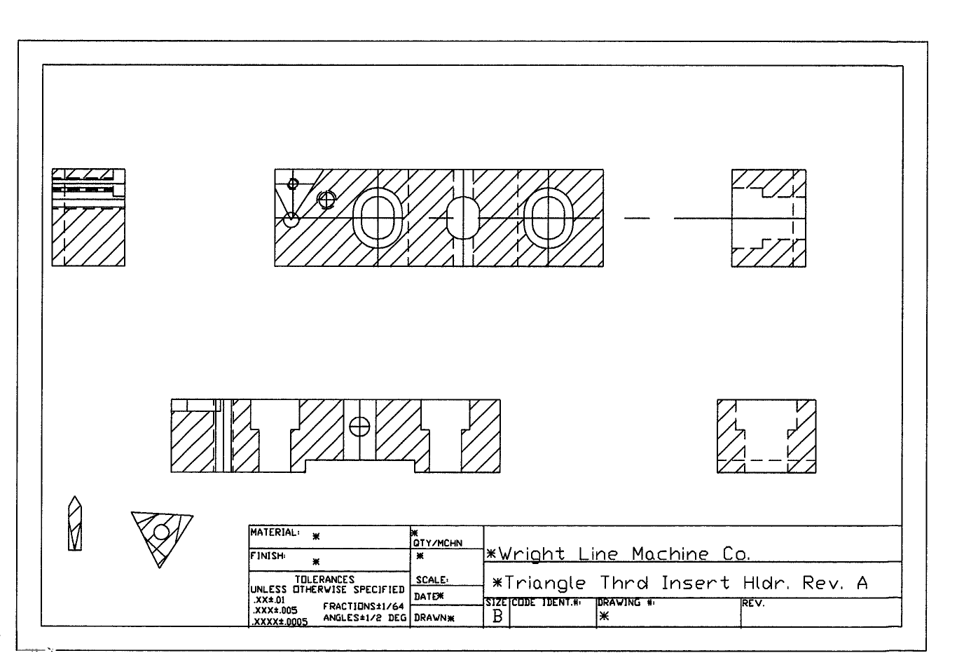

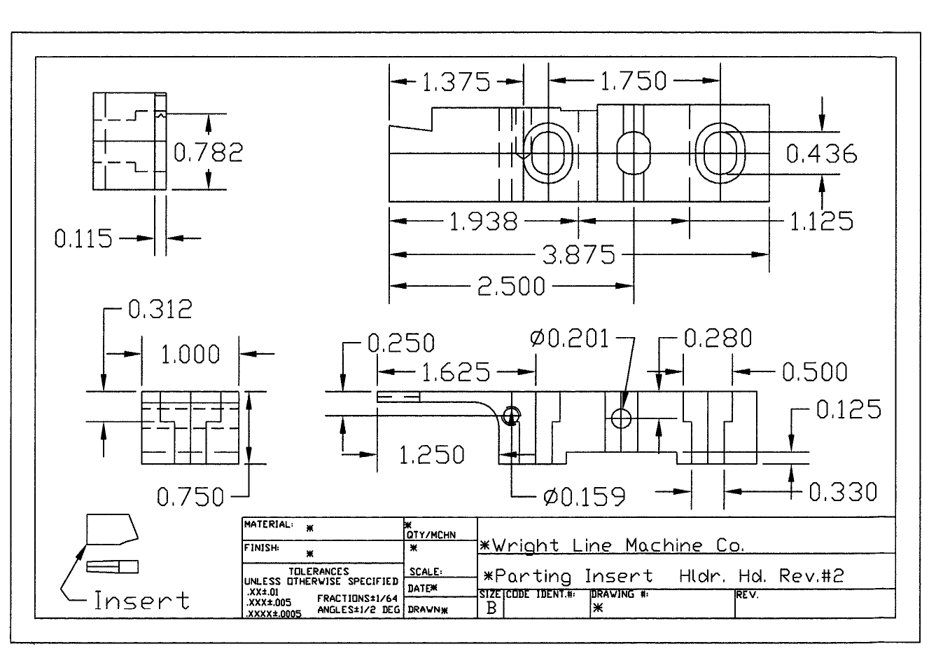

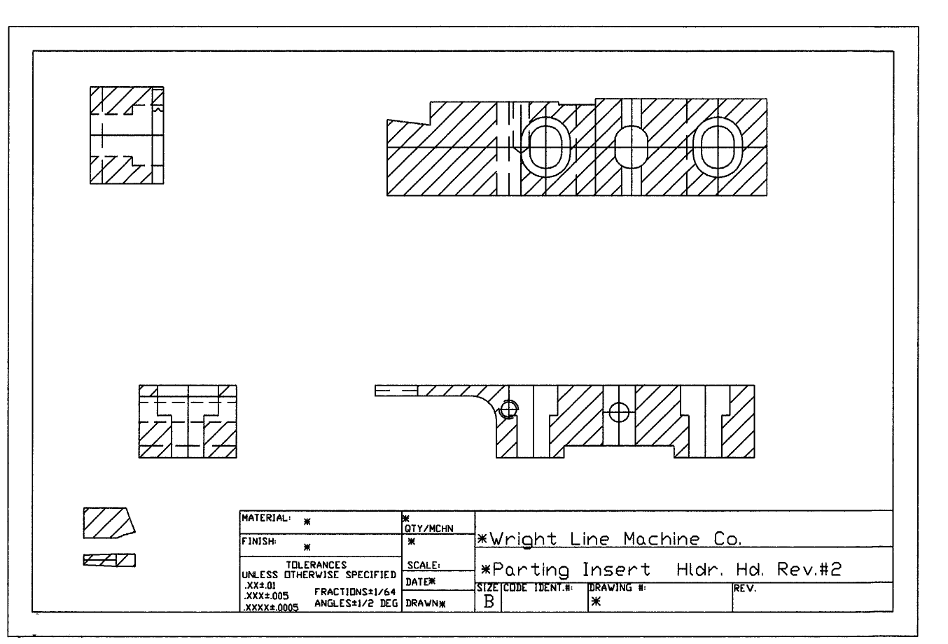

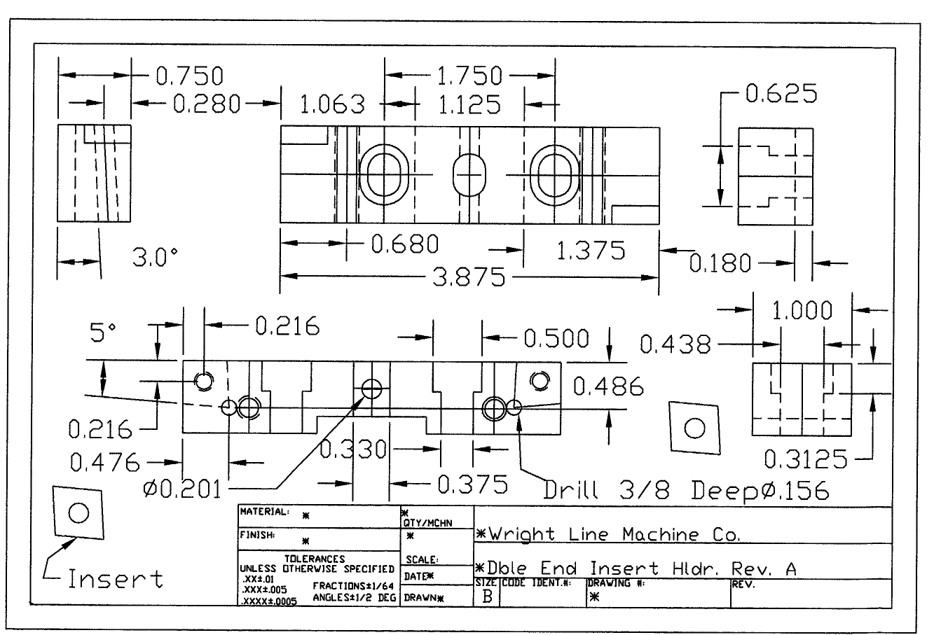

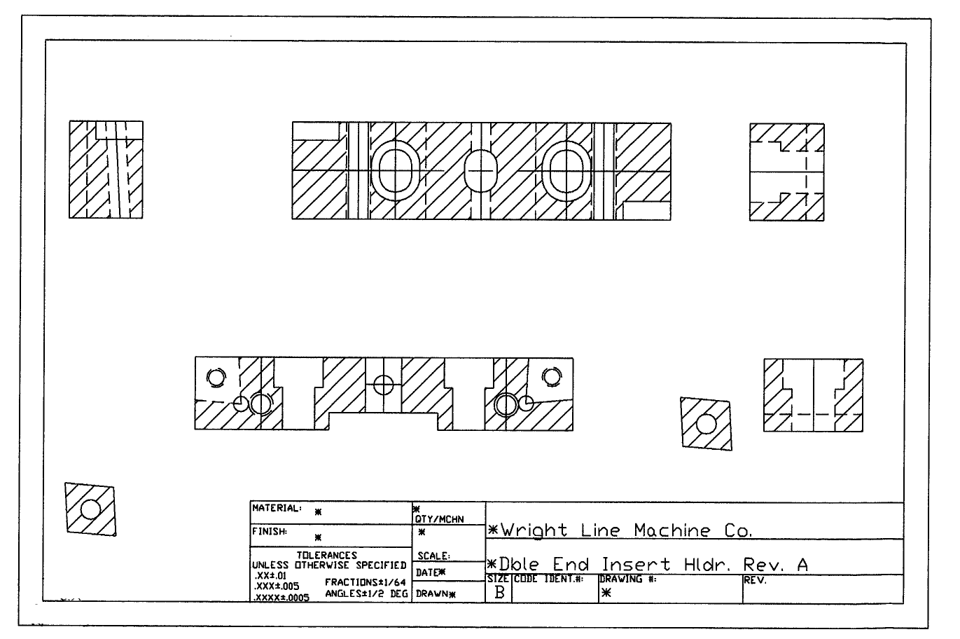

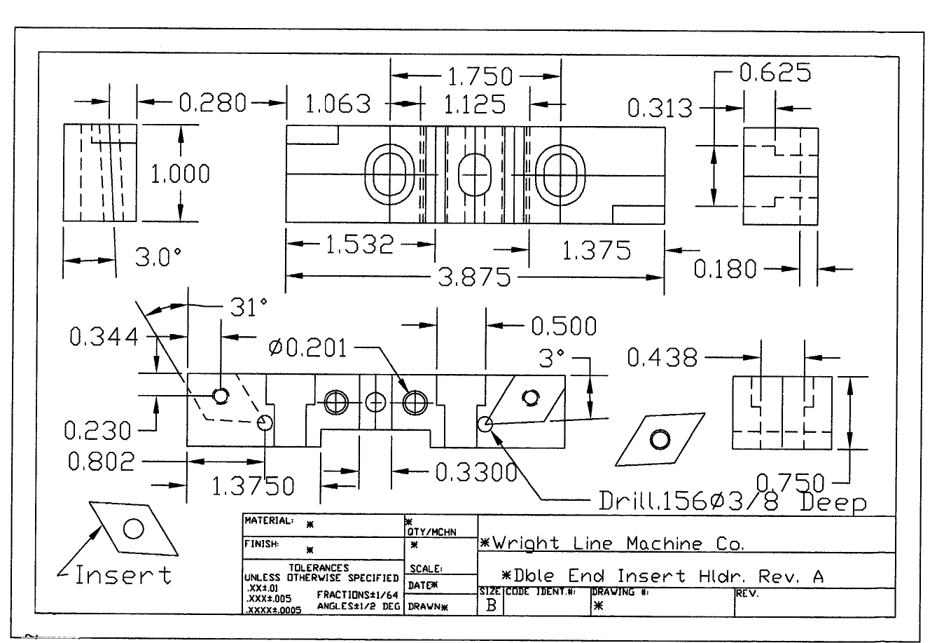

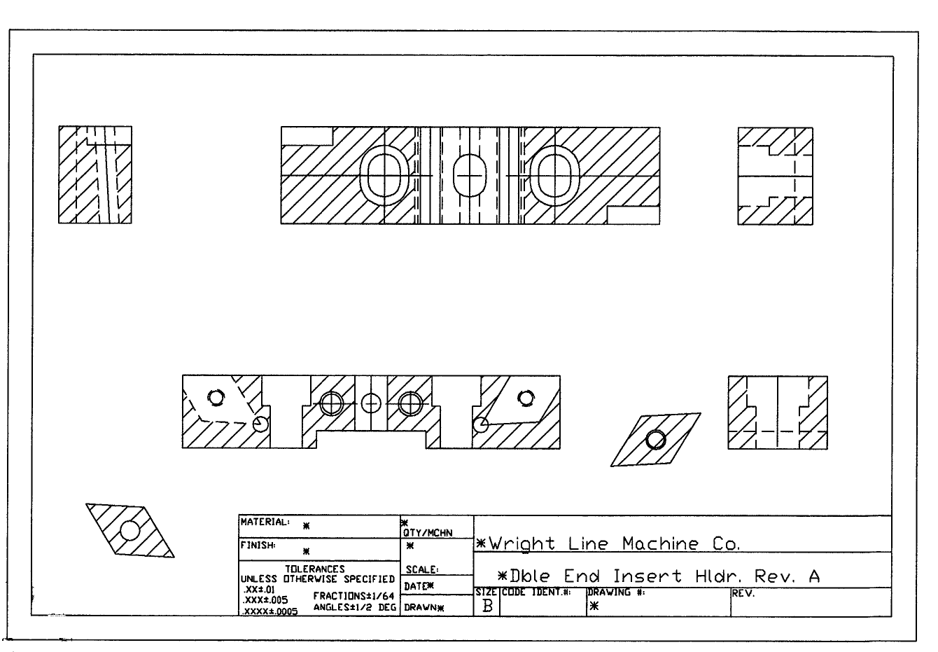

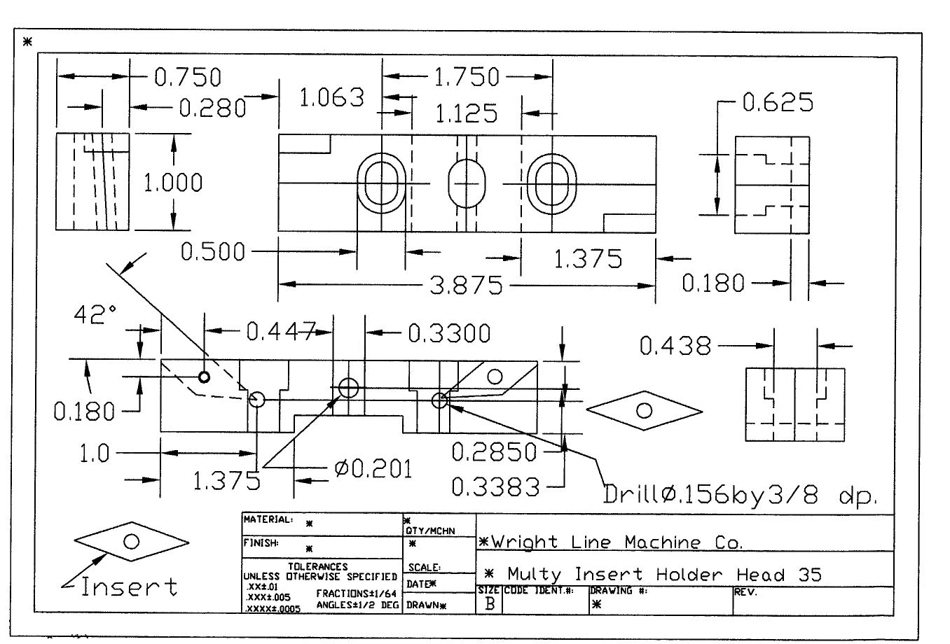

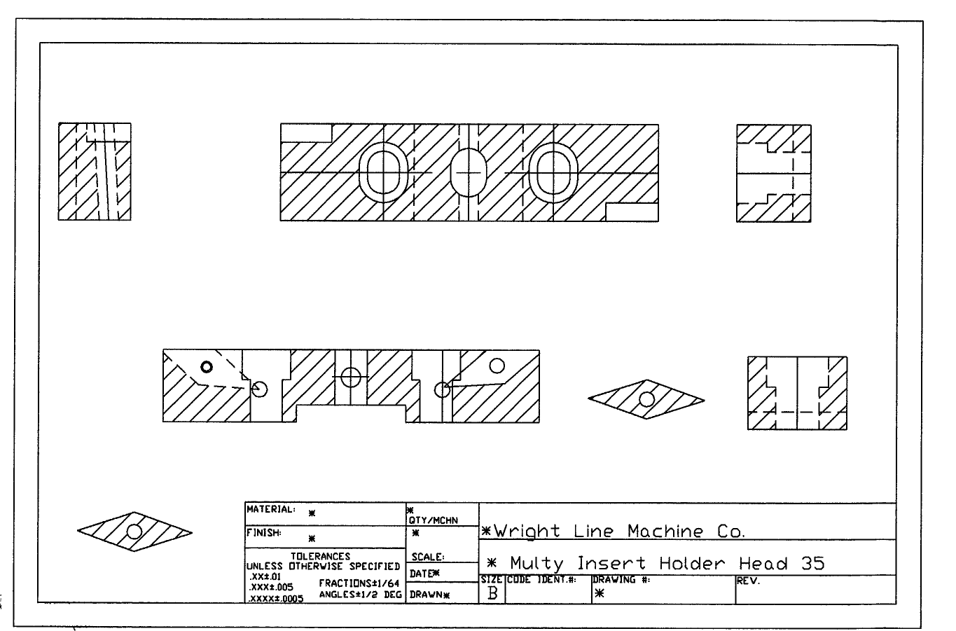

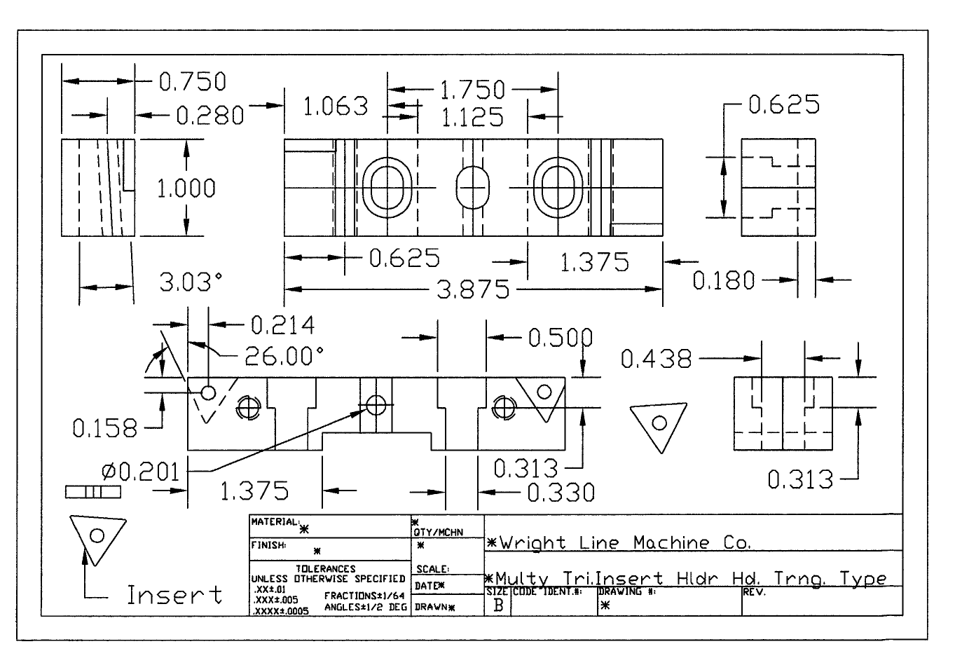

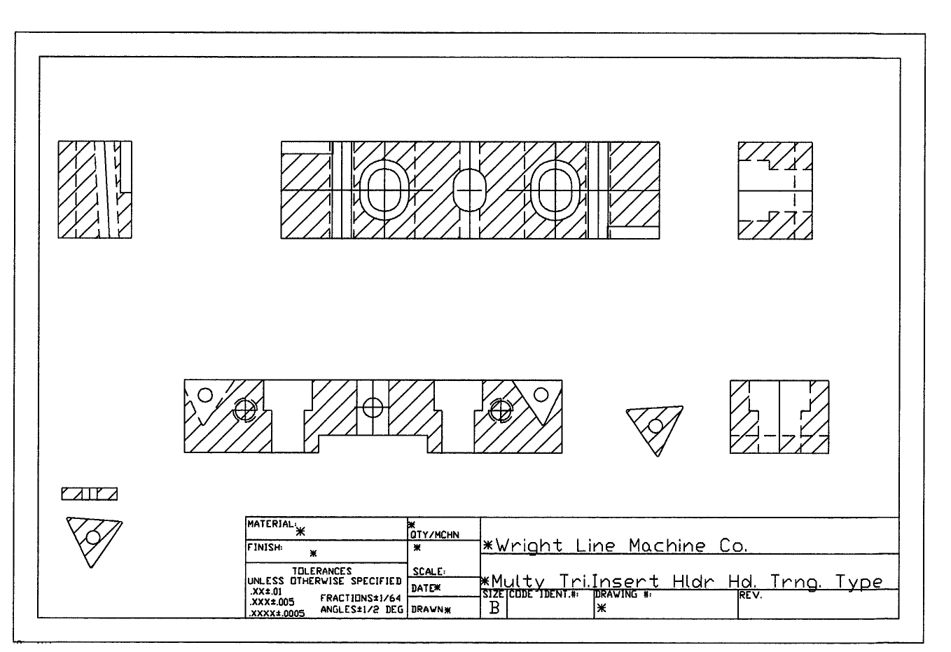

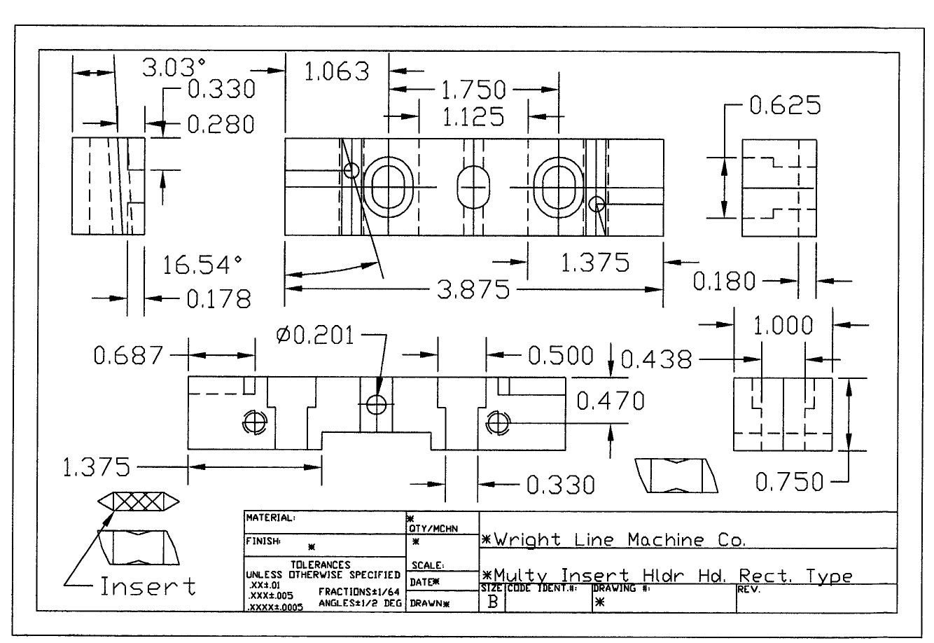

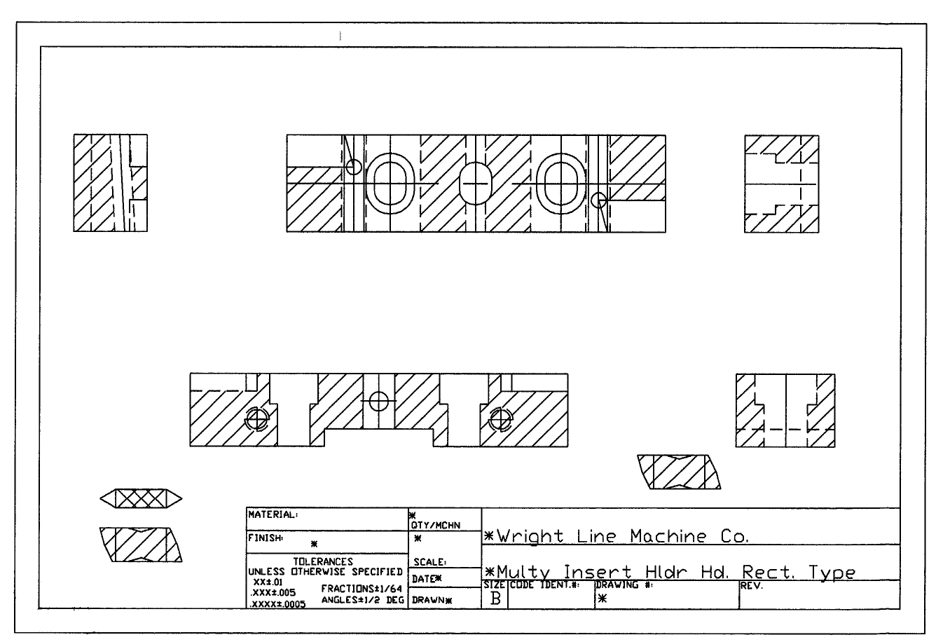

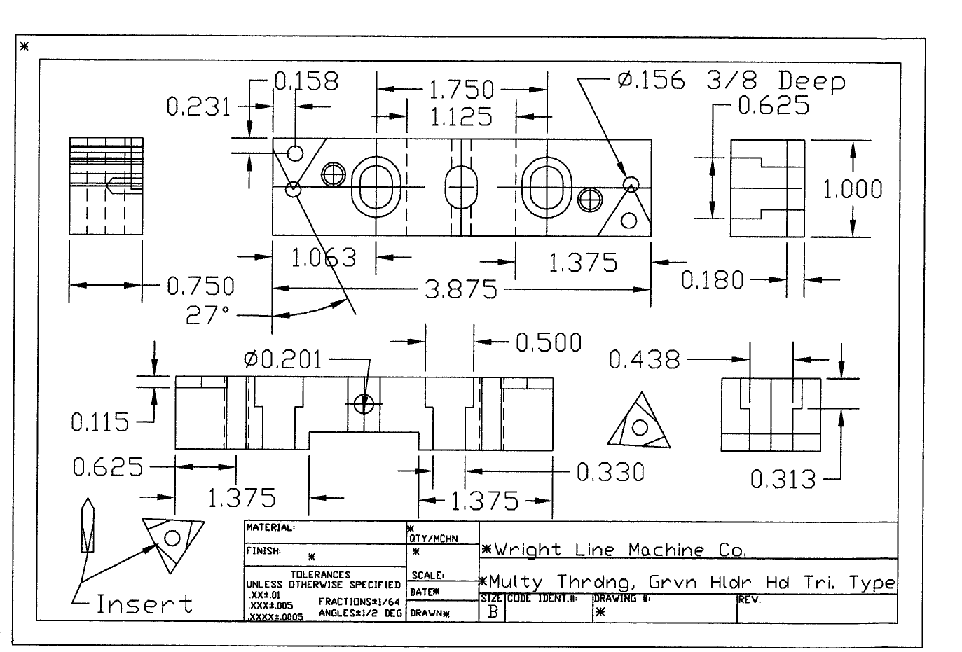

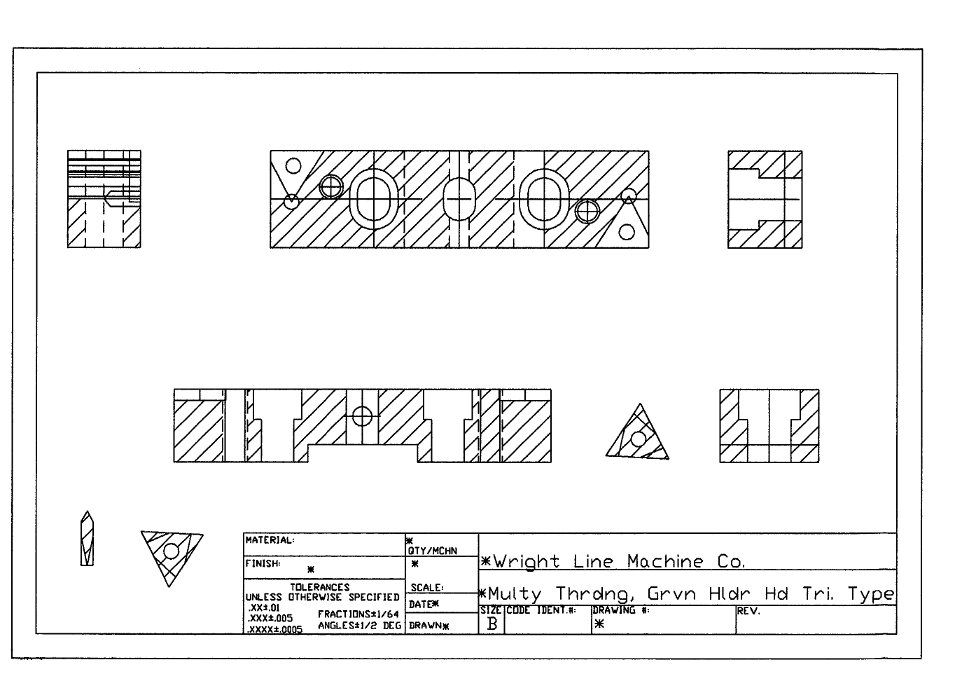

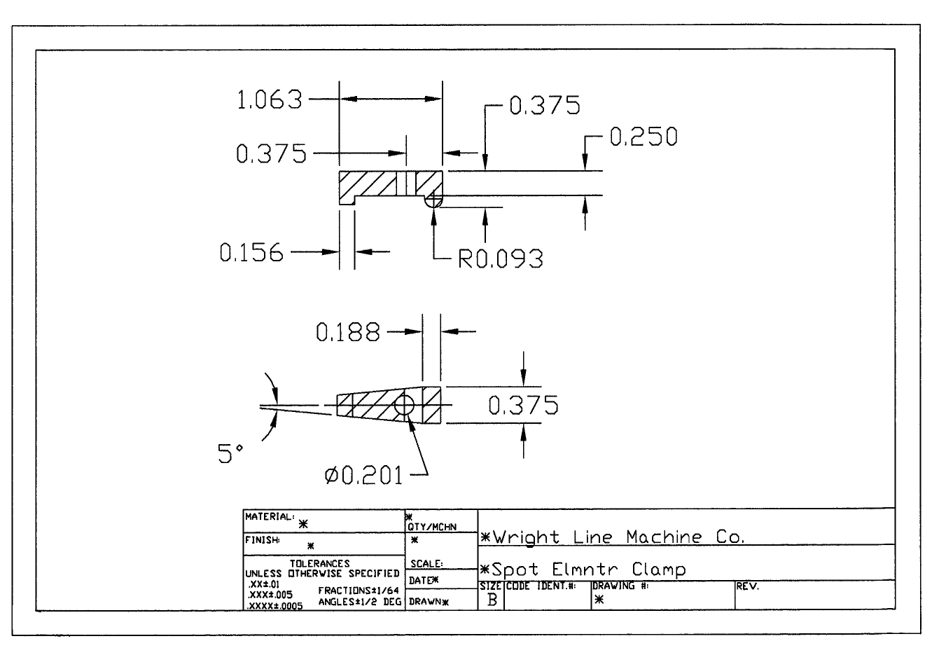

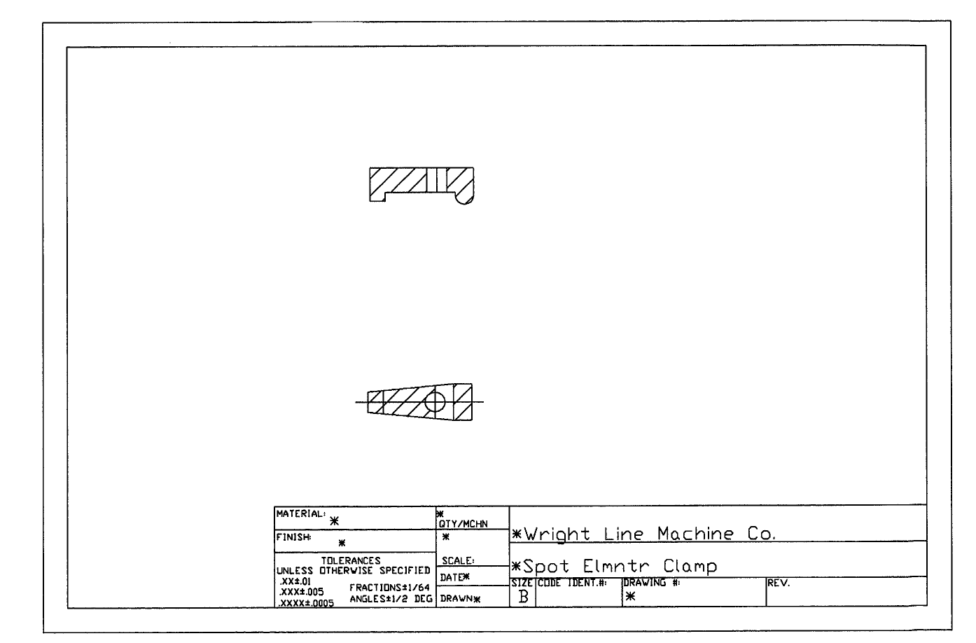

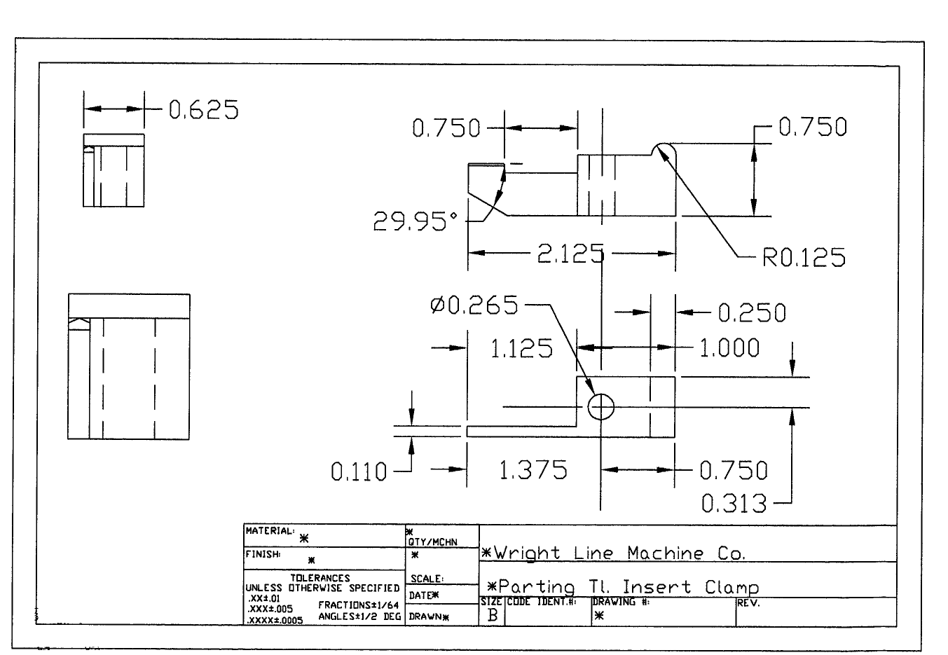

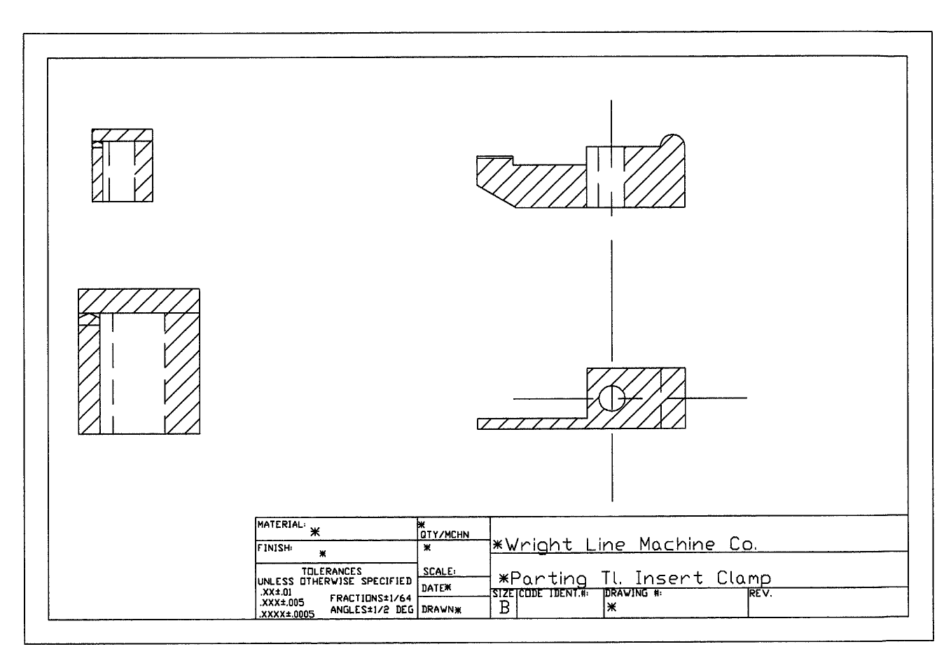

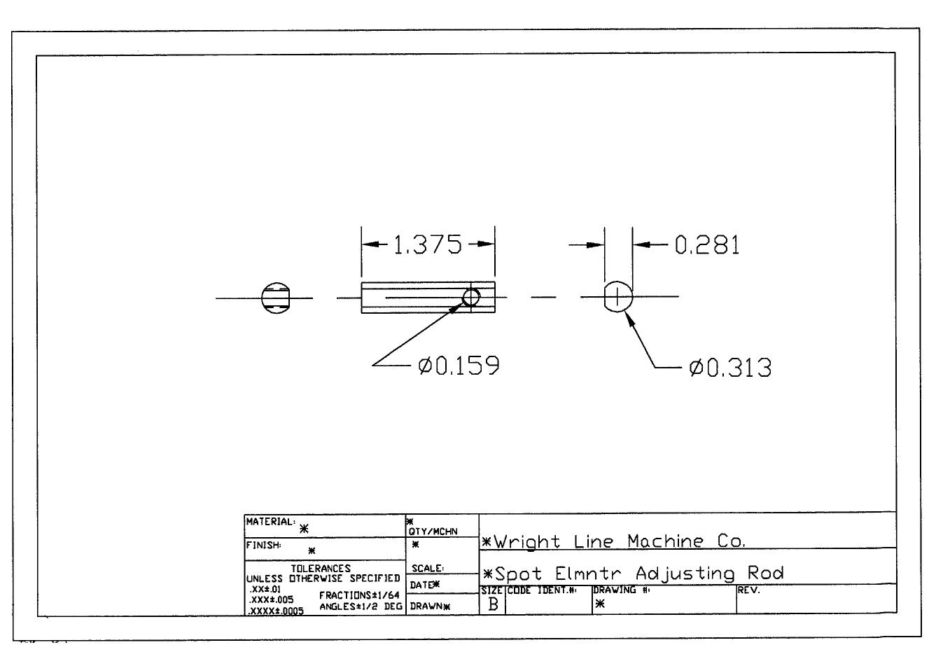

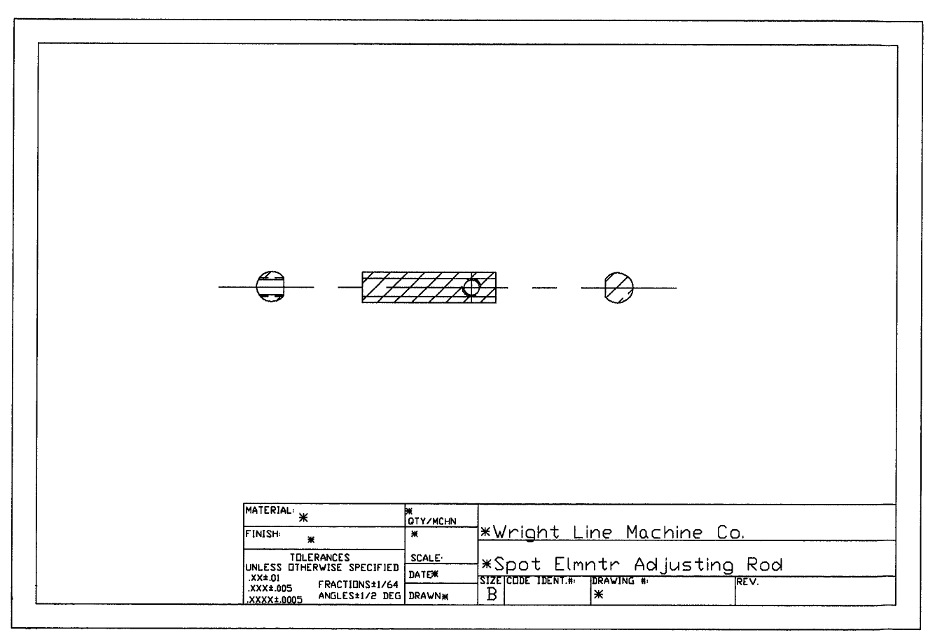

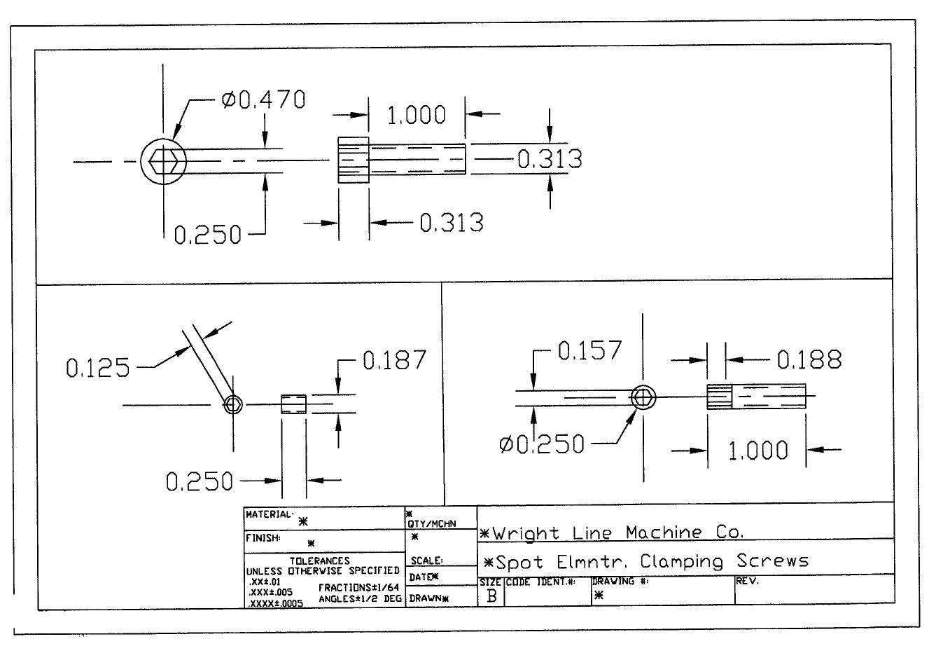

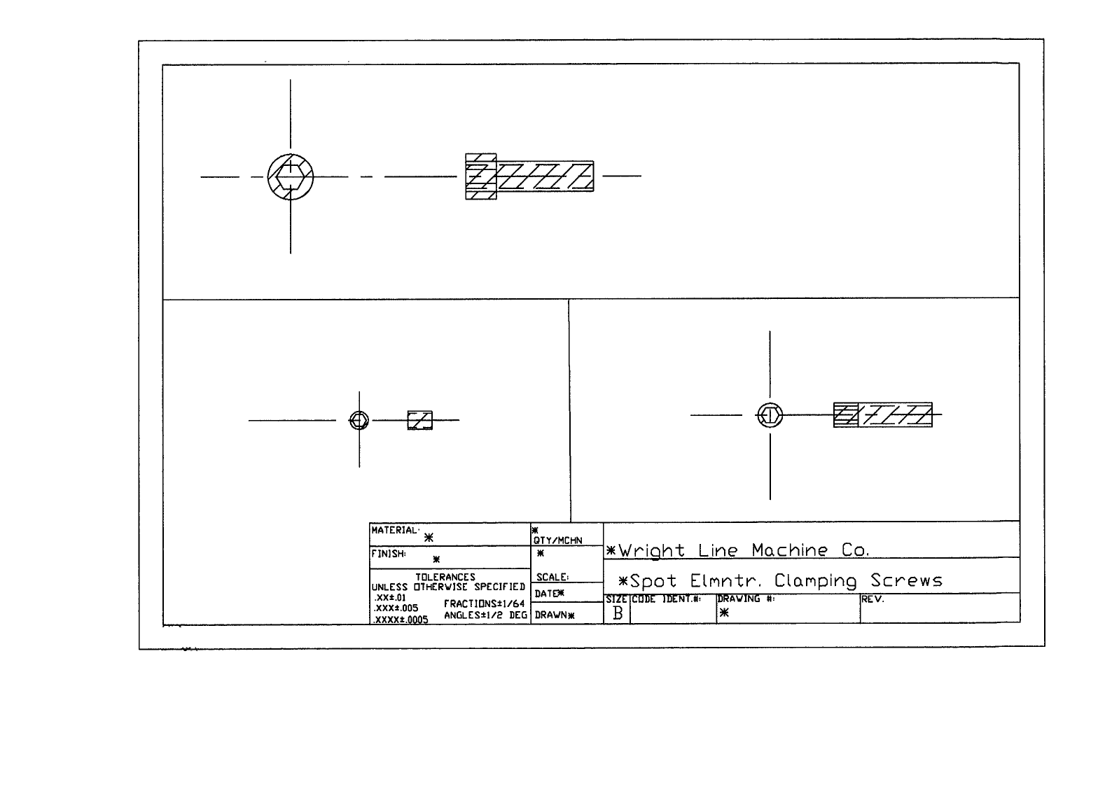

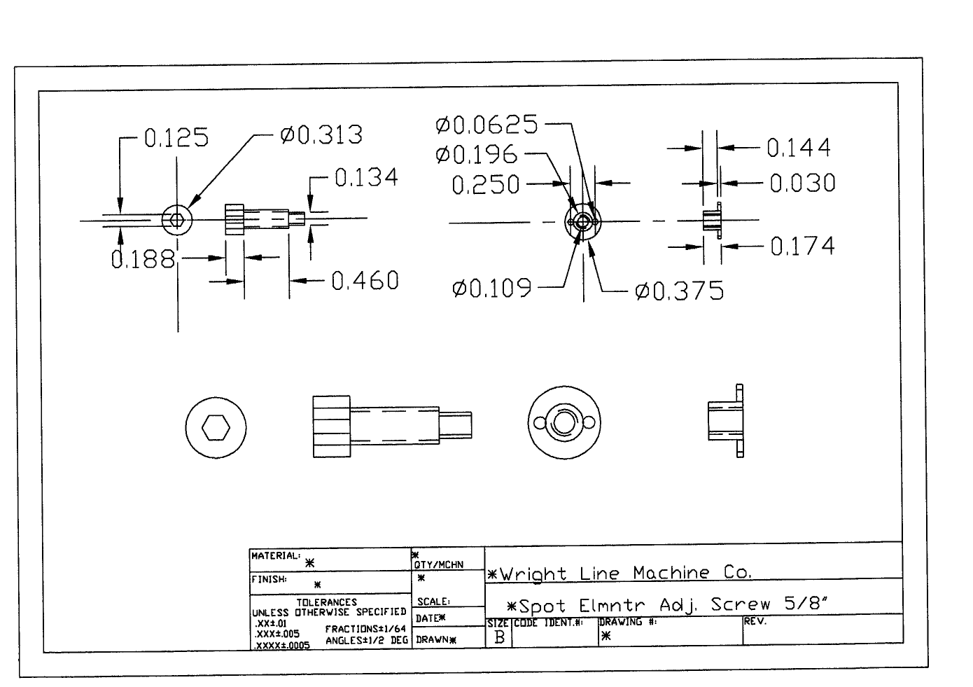

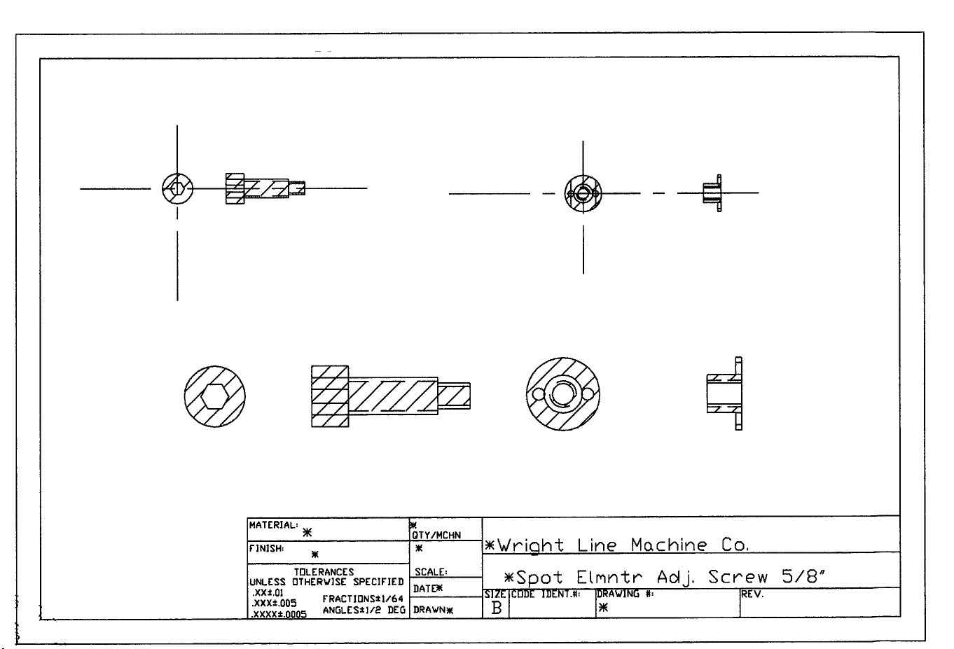

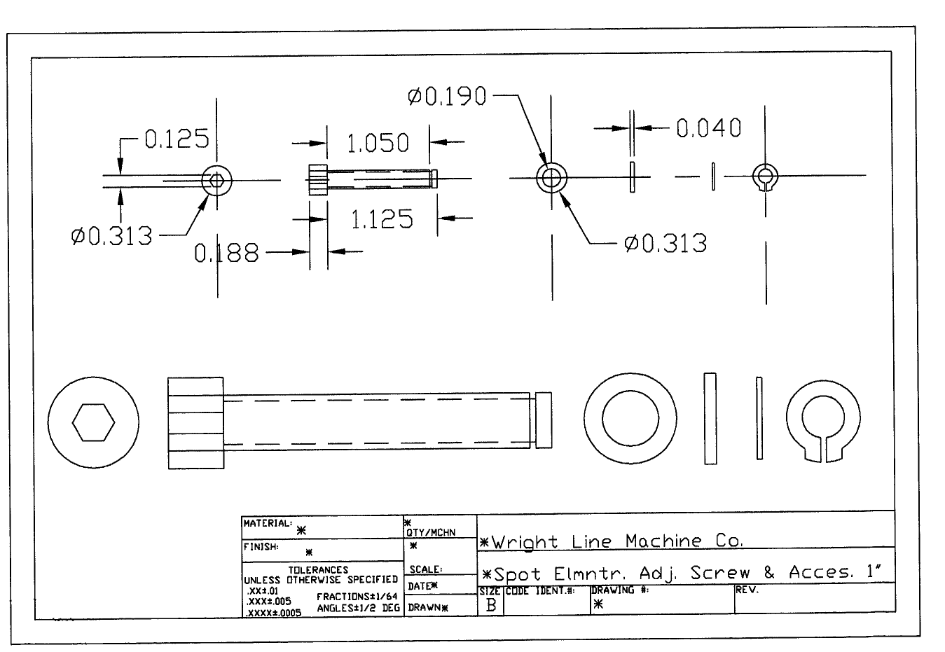

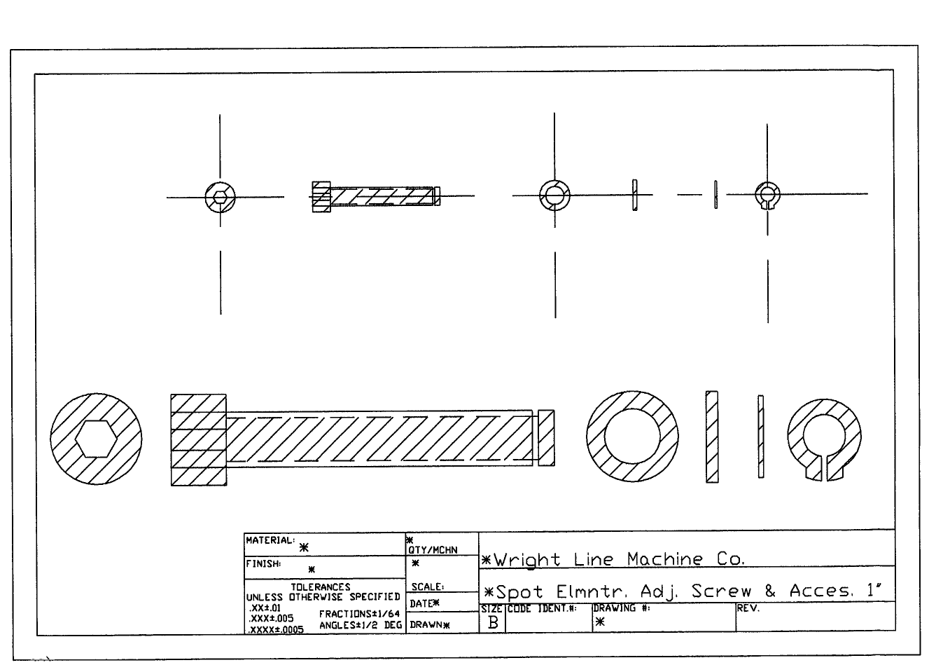

### Application Data sheet 1:5

Type of Application: Metal products manufacturing

Kind of Application: Turning, Grooving, Threading, Parting, and

Back turning, Facing and boring.

These tools have very little independent function by themselves however with the aid of a motorized conventional or automated machine tool they are unique in the processing of by-products from ferrous, nonferrous metal, plastics and other solid particle materials. These tools can be purchase from various manufactures such as Valenite, Carboloy, Circle Precision cutting tools, Kennametal, Apt, Iscar, Toolmex, Manchester tool, Dorian tools and many others.

However this new tool describe herein is uniquely different from all other tool available today that perform these machine tool function set fourth in this document known as The Spot Eliminator.

### Introduction 1:2

For over twenty-three years I have worked as a machinist in the manufacturing of precision metal components for a wide number of employers serving the needs of commercial and none commercial entities. During this time a number of application peek my interest one of which is now the spot Eliminator. A new and revolutionary approach in how CNC tools are manufactured to meet today's needs, no similar design has ever been applied to this process as far as I know were a tool renders itself adjustable without aid of another device, making this the only product that can be placed in a stationary position and provide precision adjustment vertically within manufactured range making this product new and absolutely useful in conventional and automated machining process.

### Production procedure: 1:7

(1) Purchase raw material from steel supplier, tools and hardware from hardware and tool suppliers as needed.

(2) Saw cut all material to desired length.

(3) Mill and turn to desired form.

(4) Center drill and drill all holes to required location and sizes.

(5) Tap holes as noted.

(6) Grind applicable surfaces.

(7) Alter all hardware as required.

(8) Assembly.

Throughout my career I have seen the need to provide quality service in a very competitive field and the need to delivery tool and products that work efficiently at low cost, its in this regard that I have developed this product and make the following claims

1: This tool holder is the first of its kind to be self-adjustable.

2: This design is the first of its kind applied to these tool holders.

3: This is the first tool holder that accommodates a standard brazed or high speed turning tool making it applicable in automated machining.

4: This tool is the first of it kind to feature a design that incorporates all cutting tools and make then adjustable.
